(19) United States
(12) Patent Application Publication
(10) Pub. No.: US 2026/0276807 A1
(43) Pub. Date: Sep. 17, 2026

(54) MONITORING AN ENVIRONMENT TO CONTROL AN ACTIVE REFLECTED WAVE DETECTOR

(71) Applicant: Essence SmartCare Ltd., Herzlia Pituach (IL)

(72) Inventors: Ohad AMIR, Herzlia (IL); Jonathan Mark SCHNAPP, Tel Aviv (IL)

(21) Appl. No.: 18/868,712

(22) PCT Filed: Jul. 3, 2023
(86) PCT No.: PCT/IL2023/050684

§ 371 Date: Nov. 22, 2024

(30) Foreign Application Priority Data
Jul. 8, 2022 (AU) 2022204922

(51) Int. Cl. G01S 13/58; G01J 5/00

(52) U.S. Cl. CPC G01S 13/583; G01J 5/0025

(57) ABSTRACT

An environment is monitored to control an active reflected wave detector. It is determined, based on an output from a different device to the active reflected wave detector, whether a person is at an away location that is outside a region of interest during a time period that is after a detected triggering event. In response to a predefined criterion being met, the active reflected wave detector is switched from a first state to operate in a second state in which the active reflected wave detector measures wave reflections from a region of interest. The active reflected wave detector consumes more power in the second state than in the first state. The predefined criterion comprises that the time period has expired. If a condition comprising that a person is at an away location during the time period is satisfied, it is concluded that the predefined criterion is not met.

### RELATED APPLICATION/S

This application claims the benefit of priority of Australian Patent Application No. 2022204922, filed on 8 Jul. 2022, the contents of which are incorporated herein by reference in their entirety.

### TECHNICAL FIELD

The present invention relates generally to a method, computer-readable storage medium and device for monitoring an environment to control an active reflected wave detector.

### BACKGROUND

There is a need to use a monitoring system to automatically detect and identify a state or activity of a person in a designated space, for example in an interior of a building. One example is when a person has fallen. For example, an elderly person may end up in a hazardous situation when they have fallen and are unable to call for help, or unable to do so quickly.

Some known systems have been developed in which the person wears a pendant which has an accelerometer in it to detect a fall based on kinematics. The pendant upon detecting a fall can transmit an alert signal. However the person may not want to wear, or may be in any case not wearing, the pendant.

Other systems are also known to monitor a person in a space. For example an active reflected-wave based system (i.e. a system that generates waves and measures reflections of such waves, e.g. a radar, lidar or sonar), may be used to determine an activity or a state of a person.

### SUMMARY

The inventors have identified that the known active reflected-wave based systems consume significant power. The inventors have further identified that it is desirable to not waste power operating an active reflected wave detector (such as a radar) if the person is not in the region of interest of the active reflected wave detector or if another person is nearby (e.g. who could help the person if they fall).

In general, non-limiting terms, in embodiments of the present disclosure, an active reflected wave detector is configurable to be in an a first, relatively lower powered state or a second, relatively higher powered state in which the active reflected wave detector monitors a region of interest, wherein the active reflected wave detector is configured to be put in, or be held in, a lower powered state when, based on an output from a different device to the active reflected wave detector, a person is detected as being at an away location, the away location being a specific location, or any location, that is outside the region of interest.

A first aspect of the present invention provides a computer implemented method of monitoring an environment to control an active reflected wave detector installed in a premises, wherein the active reflected wave detector is part of a system comprising at least one different device to the active reflected wave detector that is also installed in the premises. The method comprising detecting a triggering event; and determining, based on an output from at least one different device to the active reflected wave detector, whether a person is detected as being at an away location in the premises that is outside a region of interest during a time period that is after the triggering event. The method further comprises: in response to a predefined criterion being met, switching the active reflected wave detector from a first state to operate in a second state in which the active reflected wave detector measures wave reflections from a region of interest within the environment, wherein the active reflected wave detector consumes more power in the second state than in the first state, the predefined criterion comprising that the time period has expired; and in response to satisfaction of a condition comprising that a person is detected as being at an away location during the time period, concluding that the predefined criterion is not met.

In some embodiments the method further comprises, during a time period commencing with switching of the active reflected wave detector to the second state and ending with a scheduled completing of collecting measurements from the region of interest, determining, based on an output from the different device whether a person is detected as being at the away location; and in an event that a person is detected as being at the away location during the time period, ending the collecting of the measurements before the end of the time period.

In some embodiments, the active reflected wave detector is associated with a monitoring region and the region of interest is the monitoring region.

In some embodiments, the active reflected wave detector is associated with a monitoring region, and the region of interest consists of one or more sub-regions that make up less than an entirety of the monitoring region.

In some embodiments, detecting the triggering event is based on an input from a sensing device for detecting at least one of motion and presence of a person in a space.

In some embodiments, the space is correlated with said region of interest.

In some embodiments, the input is motion detection data.

In some embodiments, the motion detection data is measured by a doppler device that uses at least one item of hardware that forms the active reflected wave detector.

In some embodiments, the doppler device measures reflected waves in fewer dimensions than the active reflected wave detector.

In some embodiments, the motion detection data is measured by PIR motion detector.

In some embodiments, the method further comprises:
commencing a time window in response to the detected motion, wherein in response to further detected motion during the time window, the method comprises restarting said time window;
wherein the predefined criterion comprises that the time window has expired.

In some embodiments, the time window, from a latest of the commencing or restarting until said expiry, consists of or includes said time period.

In some embodiments, the active reflected wave detector consumes more power in the second state than the sensing device consumes when the active reflected wave detector is in the first state.

In some embodiments, the space is non-overlapping with an away location.

In some embodiments, the region of interest corresponds to a first room of a premises or a part thereof.

In some embodiments, the away location is a different room of the premises to the first room.

In some embodiments, the output from the at least one different device indicates whether a person has interacted with a different device of said at least one different device, wherein interaction with the different device requires a person to be at an away location.

In some embodiments, the at least one different device comprises one or each of: a force sensor and a smart home device.

In some embodiments, the at least one different device comprises a motion detector arranged to monitor an away location.

In some embodiments, a different device of said at least one different devices is arranged to detect a person passing a border of the region of interest to enter an away location.

In some embodiments, the or each of the at least one different device is associated with an away location wherein a person is determined to be at an away location by virtue of being detected by the at least one device or by virtue of a person interacting with the at least one device.

A second aspect of the present invention provides a device for monitoring an environment to control an active reflected wave detector installed in a premises, the active reflected wave detector being for use in a system comprising at least one different device to the active reflected wave detector that is also installed in the premises, the device being configured to: detect a triggering event; and determine, based on an output from at least one different device to the active reflected wave detector, whether a person is detected as being at an away location in the premises that is outside a region of interest during a time period that is after the triggering event. The processor is further configured to, in response to a predefined criterion being met, switch the active reflected wave detector from a first state to operate in a second state in which the active reflected wave detector measures wave reflections from a region of interest within the environment, wherein the active reflected wave detector consumes more power in the second state than in the first state, the predefined criterion comprises that the time period has expired. In response to satisfaction of a condition comprising that a person is detected as being at an away location during the time period, it is concluded that the predefined criterion is not met.

In some embodiments, the device comprises the active reflected wave detector.

In some embodiments, each of the at least one different device is housed in a housing external to the device, and the device comprises a communications interface to receive the output from the at least one different device.

In some embodiments, wherein the device consumes more power when the active reflected wave detector is in the second state than when the active reflected wave detector is in the first state.

In some embodiments, the device is configured to perform a method in accordance with the first aspect of the present invention.

A third aspect of the present invention provides a system configured to perform a method in accordance with the first aspect of the present invention, the system comprising the active reflected wave detector and one or more of the at least one different device.

A fourth aspect of the present invention provides a non-transitory computer-readable storage medium comprising instructions which, when executed by a processor cause the processor to perform the method disclosed of the first aspect of the present invention.

The instructions may be provided on one or more carriers. For example there may be one or more non-transient memories, e.g. a EEPROM (e.g. a flash memory) a disk, CD- or DVD-ROM, programmed memory such as read-only memory (e.g. for Firmware), one or more transient memories (e.g. RAM), and/or a data carrier(s) such as an optical or electrical signal carrier. The memory/memories may be integrated into a corresponding processing chip and/or separate to the chip. Code (and/or data) to implement embodiments of the present disclosure may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language.

The method of the first aspect of the present invention may be implemented on processor of a device that is in accordance with the second aspect of the invention.

These and other aspects will be apparent from the embodiments described in the following. The scope of the present disclosure is not intended to be limited by this summary nor to implementations that necessarily solve any or all of the disadvantages noted.

### BRIEF DESCRIPTION OF THE SEVERAL VIEWS OF THE DRAWINGS

For a better understanding of the present disclosure and to show how embodiments may be put into effect, reference is made to the accompanying drawings in which:

FIG. 1 illustrates an example arrangement in which a local control hub or remote server is in communication with an active reflected wave detector and a different device;

FIG. 2 illustrates an example arrangement in which a local control hub or remote server is in communication with a monitoring device and a different device;

FIG. 3 illustrates an example arrangement in which a monitoring device communicates directly with a different device;

FIG. 4 illustrates a human body with indications of reflections measured by a reflective wave detector when the person is in a standing state;

FIGS. 5a-b illustrate processes for monitoring an environment to control an active reflected wave detector;

FIG. 6 is a timing diagram to illustrate embodiments of the present invention;

FIG. 7 illustrates how the different device monitors an away location and the active reflected wave detector is associated with a monitoring region.

FIG. 8 illustrates how the active reflected wave detector may be associated with a region of interest within its monitoring region;

FIG. 9 illustrates a scenario whereby the active reflected wave detector remains in an inactive state according to embodiments of the present invention;

FIG. 10 illustrates that the different device may comprise two passive infrared (PIR) motion detectors each having a narrow field of view that are adjacent to each other.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized, and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims and their equivalents.

In the following embodiments, like components are labelled with like reference numerals.

In the following embodiments, the term data store or memory is intended to encompass any computer readable storage medium and/or device (or collection of data storage mediums and/or devices). Examples of data stores include, but are not limited to, optical disks (e.g., CD-ROM, DVD-ROM, etc.), magnetic disks (e.g., hard disks, floppy disks, etc.), memory circuits (e.g., EEPROM, solid state drives, random-access memory (RAM), etc.), and/or the like.

As used herein, except wherein the context requires otherwise, the terms “comprises”, “includes”, “has” and grammatical variants of these terms, are not intended to be exhaustive. They are intended to allow for the possibility of further additives, components, integers or steps.

The functions or algorithms described herein are implemented in hardware, software or a combination of software and hardware in one or more embodiments. The software comprises computer executable instructions stored on computer readable carrier media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor.

Specific embodiments will now be described with reference to the drawings.

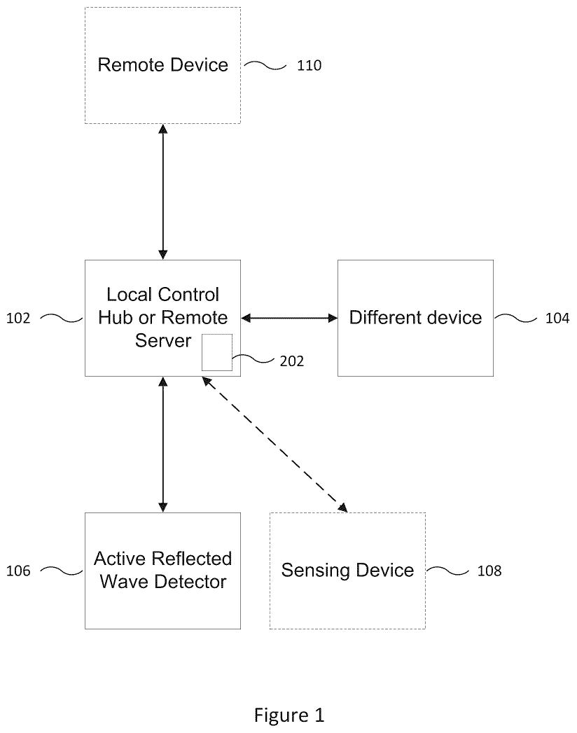

FIG. 1 illustrates one example arrangement in which a local control hub or remote server 102 is in communication with an active reflected wave detector 106 and a different device 104. The active reflected wave detector 106 and a different device 104 have different, independent housings, such that they are positioned independently of each other, generally at different positions (e.g. in different rooms), in a premises (e.g. an apartment, house or other dwelling). For example, the active reflected wave detector 106 and a different device 104 may have respective mounting brackets for mounting to different positions, e.g. on different walls.

The active reflected wave detector 106 can transmit data to, and receive data from, the local control hub or remote server 102 via a wired and/or wireless connection. Similarly, the different device 104 can transmit data to, and receive data from the local control hub or remote server 102 via a wired and/or wireless connection. The local control hub or remote server 102 comprises a communications interface to facilitate communication with external devices such as the different device 104 and remote device 110.

In embodiments whereby a local control hub 102 is used, the control hub may be a control hub of a system that may be a monitoring system and/or may be a home automation system. The local control hub 102 may for example be a wall or table mounted control hub. The control hub 102 may be “local” in that it is located in the same premises as the active reflected wave detector 106 and the different device 104. In such embodiments, the control hub 102, the active reflected wave detector 106 and the different device 104 may thus be part of a common Local Area Network (LAN), Personal Area Network (PAN) or home area network (HAN), but may more specifically be part of a common Wireless Local Area Network (WLAN), Wireless Personal Area Network (WPAN) or wireless home area network (WHAN). Communications between the control hub 102 and the active reflected wave detector 106 and the different device 104, respectively, may for example employ a protocol in accordance with or similar to IEEE 802.15.4, a long-range wireless communication protocol (e.g. Amazon Sidewalk™), Bluetooth™, or Wi-Fi™. Thus optionally the control hub 102 may be considered as “local” to the active reflected wave detector 106 based on them being in the same LAN, PAN or HAN.

In contrast, in embodiments whereby a remote server 102 is used, the remote server 102 is not located in the same premises as the active reflected wave detector 106 and the different device 104. For such embodiments, the remote server 102, the active reflected wave detector 106 and the different device 104 may be part of Wide Area Network (WAN), e.g. the Internet, and may each have different WAN addresses for use in communications between the remote server 102 and the active reflected wave detector 106 and the different device 104. Such communications over the WAN may be facilitated by the active reflected wave detector 106 and the different device 104, each having a cellular modem, but optionally may additionally or alternatively have a Wi-Fi™ and/or Ethernet interface, for example.

The local control hub or remote server 102 comprises a processing module 202. In some embodiments, the processing module 202 of the local control hub or remote server 102 controls the activation of the active reflected wave detector 106 in accordance with embodiments of the present disclosure.

In an activated state (e.g. a higher power consumption operating state) the active reflected wave detector 106 operates to measure wave reflections from an environment. The active reflected wave detector 106 may measure coordinates corresponding to any locations of reflection, and thereby may determine a position and/or configuration of an object (e.g. a person) and/or may track an object. This can be particularly useful in determining a status of a person. Though the active reflected wave detector 106 may also measure doppler, the active reflected wave detector 106 contrasts with doppler-only devices which can only detect motion (i.e. they cannot not detect locations of reflections). The environment in which the active reflected wave detector 106 may be used may be a premises comprising a building or a part of such a premises, which may be a residence or dwelling, e.g. a house or an apartment, or a room. The environment may be or comprise an indoor space, with the active reflected wave detector 106 being, for example, wall mounted to look across an indoor space from an elevated mounted location (e.g. in a range of 1.8-2.4 meters above the ground). The active reflected wave detector 106 may operate in accordance with any one of various reflected wave technologies.

Preferably, the active reflected wave detector 106 is a radar sensor. The radar sensor 106 may use millimeter wave (mmWave) sensing technology. The radar is, in some embodiments, a continuous-wave radar, such as frequency modulated continuous wave (FMCW) technology. Such a chip with such technology may be, for example, Texas Instruments Inc. part number IWR6843. The radar may operate in microwave frequencies, e.g. in some embodiments a carrier wave in the range of 1-100 GHz (76-81 Ghz or 57-64 GHz in some embodiments), and/or radio waves in the 300 MHz to 300 GHz range, and/or millimeter waves in the 30 GHz to 300 GHz range. In some embodiments, the radar has a bandwidth of at least 1 GHz. The active reflected wave detector 106 may comprise antennas for both emitting waves and for receiving reflections of the emitted waves, and in some embodiment different antennas may be used for the emitting compared with the receiving.

The active reflected wave detector 106 is associated with a “monitoring region”. The monitoring region is the region in the environment that the active reflected wave detector 106 observes, when operational, as may be defined by its field of view and range limits. The range limits may comprise maximum and minimum distance limits, between which an object needs to be positioned in order to be detectable. In the examples provided herein only an upper distance limit is referred to, and any minimum distance away from the active reflected wave detector 106 that may be needed for an objected to be detected is treated as being negligible. In the example of the active reflected wave detector 106 being a radar, the monitoring region may be alternatively termed “radar observing region”. The monitoring region may, for example, define the region in which objects are detectable by the active reflected wave detector 106. Thus the monitoring region may be referred to herein as the maximum region that the active reflected wave detector is configured to monitor. Such a maximum region is understood herein to be no greater than the region in which the active reflected wave detector is able to ensure that one or more minimum performance level requirements are met. The monitoring by the active reflected wave detector 106 (e.g. a radar) may be, or include, any one or more of observing, checking, or keeping a continuous record of reflective wave measurements (e.g. radar measurements). Further, there may be different parts of the monitoring region that are monitored in respectively different ways. For example, it may be that reflective wave measurements (e.g. radar measurements) are performed and tested against a certain condition for one part of the monitoring region, such as a region of interest, whereas reflective wave measurements (e.g. radar measurements) for another part of the monitoring region, such as the remaining area outside the region of interest, may merely be performed but then disregarded. The disregarding of such measurements may for example be because they are outside the region of interest. For example, the monitoring may comprise generating reflective wave measurements (e.g. radar measurements) for all of the monitoring region and subsequently reducing the set of measurements to be confined to a smaller area that is under surveillance.

A region of interest is, or is within, the monitoring region. In particular, the region of interest may be the same as the monitoring region or may consist of one or more sub-regions of the monitoring region that make up less than an entirety of the monitoring region. For example a virtual fence may be defined along a perimeter of the region of interest, wherein the region of interest is part of the monitoring region. A user may be able to define one or more “region of interest” associated with the active reflected wave detector 106. The region of interest may be defined on a case-by-case basis at installation, depending on the use case, e.g. the environment in which it is installed.

As will be appreciated the active reflected wave detector 106 is an “active” detector in the sense of it relying on delivery of waves from an integrated source in order to receive reflections of the waves. The active reflected wave detector 106 is not limited to being a radar sensor, and in other embodiments alternative active reflected wave detectors may be used, for example the active reflected wave detector 106 may be a LIDAR sensor, or a sonar sensor.

The active reflected wave detector 106 being a radar sensor is advantageous over other reflected wave technologies in that radar signals can transmit through some materials, e.g. wood or plastic, but not others-notably water which is important because humans are mostly water. This means that the radar, unlike sonar or lidar, may be able to “see” a person in the region of interest even if they are behind solid furnishings consisting of a material(s) transmissive to radar signals.

The different device 104 is configured to detect if a person is at an away location, i.e. that a person is at a location that is not in the region of interest associated with the detector 106. We refer herein to a single different device 104, however there may be multiple different devices each configured to detect if a person is at a respective away location monitored by the particular different device. In some embodiments, the output from the different device 104 indicates whether a person has interacted with the different device 104, whereby interaction with the different device 104 requires the person to be at an away location. This interaction can be sensed using one or more sensor modalities including sensing sound, force, touch, vibration, movement etc.

The region of interest of the active reflected wave detector 106 may for example encompass at least part of a first room of a premises, and the away location may for example be a different room (of the premises) to the first room. As another example, the region of interest of the active reflected wave detector 106 may for example encompass a part of a first room of a premises, and the away location may for example be a different part of the first room. The away location may optionally be a location proximate to the region of interest, e.g. in an adjacent room in an embodiment, in a same premises (especially for relatively small premises) or on a same story of a multi-story premises. Alternatively, in some implementations, to more easily ensure there is no accidental overlapping between the away location and the region of interest, the away location may deliberately be at a location that is distant from the region of interest, for example in a non-adjacent room or on a different story of a multi-story premises.

The different device 104 may be a force sensor at the away location. The force sensor may be located on or in a floor of a room to detect the person standing and exerting a force on the force sensor.

The different device 104 may be a smart home device (e.g. a home feature or a consumer appliance). The smart home device may be fixed in the environment at the away location, e.g. a light switch, door sensor etc. Alternatively, the smart home device may be movable and positioned in the environment at the away location. For example the smart home device may be a consumer appliance such as a television, a refrigerator, a smart-home hub, etc.

The different device 104 may be a motion detector that monitors the away location. In contrast with the active reflected wave detector 106, the motion detector may optionally be a passive technology, e.g. a PIR motion detector, which therefore does not emit radiation. In other embodiments, non-ranging active reflected wave detectors, e.g. doppler only systems, may be used for motion detection. In either example, the motion detector may consume less power than the active reflected wave detector 106.

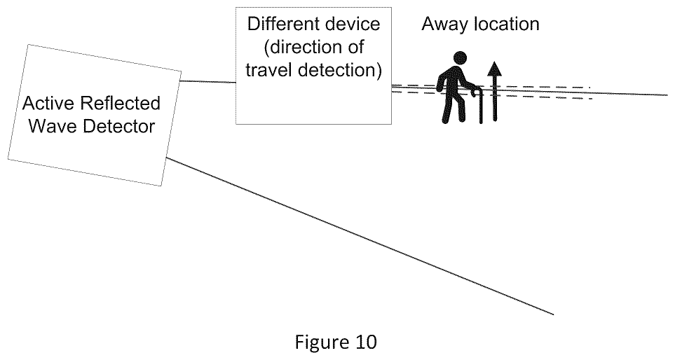

The person may optionally be determined to be at the away location based on a different device 104 that is configured to detect that the person has travelled in a direction that is away from the region of interest of the active reflected wave detector 106, wherein the different device 104 monitors a part of a border of the region of interest (e.g. where the region of interest is a room, the different device 104 may be configured to detect the person passing through a doorway that exits from the room), and to detect a direction of travel to thereby determine when a person leaves and enters the region of interest via the part of the border being monitored. This is illustrated in FIG. 10. For example, the different device 104 may comprise two PIR motion detectors each having a narrow field of view that are adjacent to each other, so direction can be determined based on the order of the PIRs in detecting motion.

The local control hub or remote server 102 may be in communication with a sensing device 108. The sensing device 108 can transmit data to, and receive data from, the local control hub or remote server 102 via a wired and/or wireless connection. The sensing device 108 is configured to detect at least one of motion and presence of a person in a space. The space is correlated with the region of interest of the active reflected wave detector 106. For example, the space monitored by the sensing device 108 may comprise the region of interest, or be within the region of interest, or substantially overlap with the region of interest of the active reflected wave detector 106.

As one example, the sensing device 108 may be a motion detector that monitors the space. In some embodiments the motion detector is a PIR motion detector. In other examples, the motion detector may be comprise a doppler-based motion detector, e.g. based on ultrasound or reflected electromagnetic waves. For power efficiency, such a doppler-based motion detector may advantageously determine only single dimensional measurements. Optionally the doppler-based motion detector comprises at least one transducer (e.g. an antenna) for receiving reflected waves from the space 902. For example, only one such transducer is needed for measuring reflected waves in a single dimension. In some embodiments the active reflected wave detector 106 also provides the doppler measurements used by the motion detector 108. In other embodiments in which the motion detector 108 is a doppler based motion detector, the active reflected wave detector 106 and the motion detector 108 share at least some common hardware for processing reflected wave data but have different wave-interfacing transducers (e.g. different transmitting antennas and/or different receiving antennas). In yet other embodiments in which the motion detector 108 is a doppler based motion detector, the active reflected wave detector 106 and the motion detector 108 are provided by entirely distinct items of hardware.

When switched to a higher power consumption state for collecting measurements to determine a status of the environment (relating more particularly to the region of interest in the environment) or of a person in the environment (which may involve collecting spatial measurements in 3 dimensions), the active reflected wave detector may consume more power than the sensing device 108 does to detect motion. The motion detector 108 is configured to detect motion in a motion detection monitoring region in the environment. The lateral field of view of the motion detector 108 may be between 100° and 120°. It will be appreciated that this angle range is merely an example, the lateral field of view of the motion detector 108 may be up to 160° or higher. The motion detection monitoring region has a maximum range. If an object is moving beyond the maximum range of the motion detector 108, the motion detector 108 will not detect this movement, or at least not as reliably (e.g. the motion sensor may not meet its performance specifications).

For simplicity in various examples described herein the active reflected wave detector 106 is referred to as being ‘activated’. In each of these examples the reader is to understand that this may alternatively be ‘switched from a first state to a second state that consumes more power than the first state’. In some embodiments the active reflected wave detector 106 may be deactivated in the first state, but in other embodiments the active reflected wave detector may be operational in the first state. For example, in some embodiments the active reflected wave detector may, in the first date, collect measurements in a manner that consumes less power than when in a second state, for example by collecting measurements less often or my operating with fewer wave-interfacing receivers and/or fewer wave-interfacing receivers. For example, to classify a status of person based on reflected wave measurements the active reflected wave detector may, in the second state, perform 3-dimensional spatial measurements, whereas it may operate in the first state to perform 1-dimensional doppler measurements if acting as the motion detector 108.

It will be appreciated that the sensing device 108 being a motion detector is merely an example, and the sensing device may advantageous be part of the monitoring device 200, and the sensing device 108 may in other embodiments be another type of activity sensor and/or separate from the monitoring device 200, e.g. a floor sensor or other sensor.

Preferably, the space monitored by the sensing device 108 is non-overlapping with the/each away location. For example, the space is not overlapping with the away location if only one away location is monitored or not overlapping with any away locations if multiple away locations are monitored. That it be non-overlapping is advantageous by avoiding the possibility of a person detected in an away location associated with a different device 104 simultaneously being detected by the sensing device 108.

The local control hub or remote server 102 may be in communication with a remote device 110. This allows the local control hub or remote server 102 to transmit a notification to the remote device 110, for example an alert message if a person is detected as having fallen. The remote device 110 may for example be a mobile computing device (e.g. a tablet or smartphone) associated with a carer or relative. Alternatively the remote device may be a computing device in a remote location (e.g. a personal computer, or a server of a monitoring station).

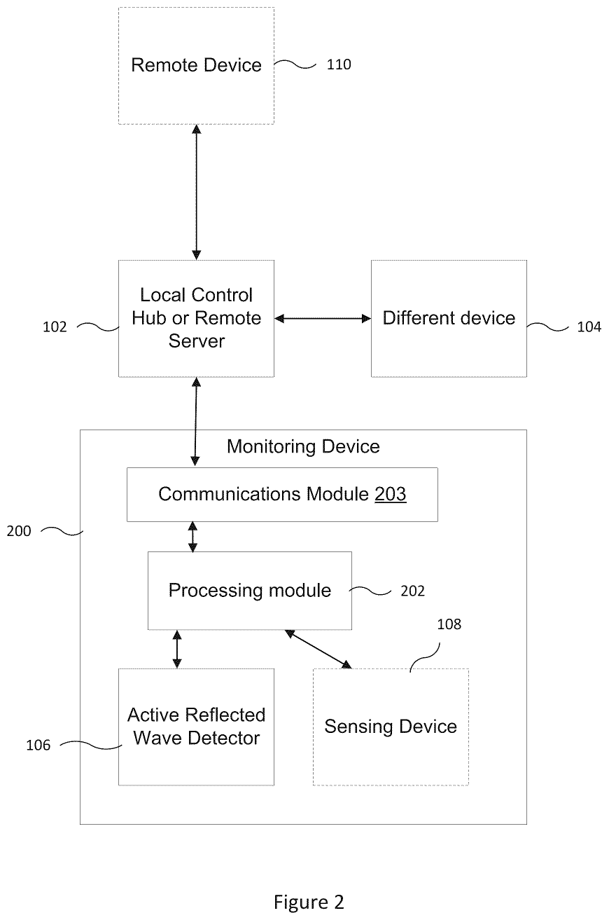

FIG. 2 illustrates a further example arrangement in which a local control hub or remote server 102 is in communication with a monitoring device 200 and a different device 104.

The monitoring device 200 comprises the processing module 202 and the active reflected wave detector 106, and may further comprise the sensing device 108. The monitoring device 200 may use a communications module 203 (optionally a wired and/or wireless communications module, but in some embodiments at least a wireless communications module) to communicate with the different device 104 (and optionally the remote device 110) via the local control hub or remote server 102, but it is the processing module 202 of the monitoring device 200 which controls the activation of the active reflected wave detector 106 in accordance with embodiments of the present disclosure. In other embodiments, in which the sensing device 108 is not part of the monitoring device 200, the sensing device 108 may optionally still be present in another manner, for example as an independent device in communication with the local hub or remote server 102.

The monitoring device 200 comprises a communications interface to facilitate communication with the local control hub or remote server 102 via a wired and/or wireless connection.

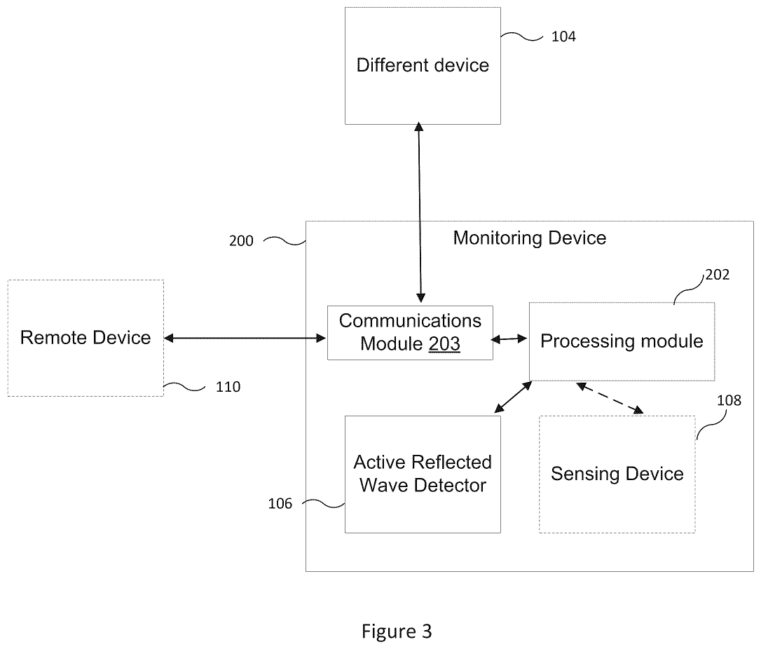

FIG. 3 illustrates another example arrangement in which there is no local control hub interfacing with the monitoring device 200, and in which the monitoring device 200 communicates directly with the different device 104 (and optionally the remote device 110). Again, in this arrangement it is the processing module 202 of the monitoring device 200 which controls the activation of the active reflected wave detector 106 in accordance with embodiments of the present disclosure.

In the example of FIG. 3, the monitoring device 200 comprises a communications interface to facilitate communication with external devices such as the different device 104 and remote device 110.

In each of the examples of FIGS. 1 to 3, a remote server may optionally be provided to manage and handles messages from a plurality of monitoring devices 200 and/or active wave reflectors 106 installed at different locations and/or different premises. Such a remote server may for example be provided by the remote device 110 and/or the remote server 102.

The functionality of the processing module 202 described herein may be implemented in code (software) stored on a memory comprising one or more storage media, and arranged for execution on a processor comprising one or more processing units, which optionally may be distributed amongst different devices of the system disclosed herein, e.g. the active reflected wave detector 106 the at least one different device and/or the local control hub or remote server 102. Further, the processing module 202 may be implemented using processing resources that also form part of the active reflected wave detector 106 and/or the sensing device 108. The storage media may be integrated into and/or separate from the processing module 202. The code is configured so as when fetched from the memory and executed on the processor (e.g. one or more microprocessors, microcontrollers or any other type of code-reading processor, or combination thereof) to perform operations in line with embodiments discussed herein. Alternatively it is not excluded that some or all of the functionality of the processing module 202 or processing unit(s) thereof is implemented in dedicated hardware circuitry, or configurable hardware circuitry, e.g. an FPGA, and/or a combination of discrete analog and/or digital circuits and components.

In operation, the active reflected wave detector 106 performs one or more reflected wave measurements at a given moment of time, and over time these reflected wave measurements can be analysed by the processing module 202 to determine the presence of a person and/or a state and/or activity of a present person and/or a condition of a present person. In other embodiments, some or all of such analysis may instead be performed upstream, for example by remote device 110. In either case, the active reflected wave detector 106, in some embodiments, more specifically forms part of a fall detector.

In the context of the present disclosure, the state of the person may be a characterization of the person based on a momentary assessment. For example, a classification based on their position (e.g. in a location in respect to the floor and in a configuration which are consistent or inconsistent with having fallen) and/or their kinematics (e.g. whether they have a velocity that is consistent or inconsistent with them having fallen, or having fallen possibly being immobile). In the context of the present disclosure, the condition of the person may comprise a determination of an aspect of the person's health or physical predicament, for example whether they are in a fall condition whereby they have fallen and are substantially immobile, such that they may not be able (physically and/or emotionally) to get to a phone to call for help. In some embodiments this involves an assessment of the person's status over time, such as in the order or 30-60 seconds. However, the condition of the person may in some contexts be synonymous with the status of the person. For example, by determining that the person is in a safe supported state or a standing state, it may be concluded that the person is not currently in a fall condition, whereby they are on the floor and potentially unable to seek help. It may additionally or alternatively be concluded that they are in a resting condition because of their status being determined to be in a safe supported state, e.g. lying on a bed. In another example their condition may be classified as active and/or mobile based on a determination of a walking status.

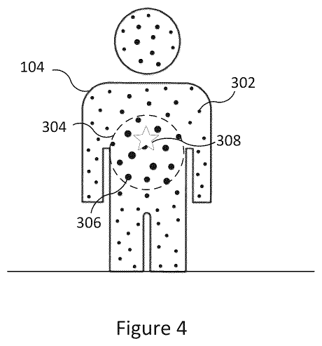

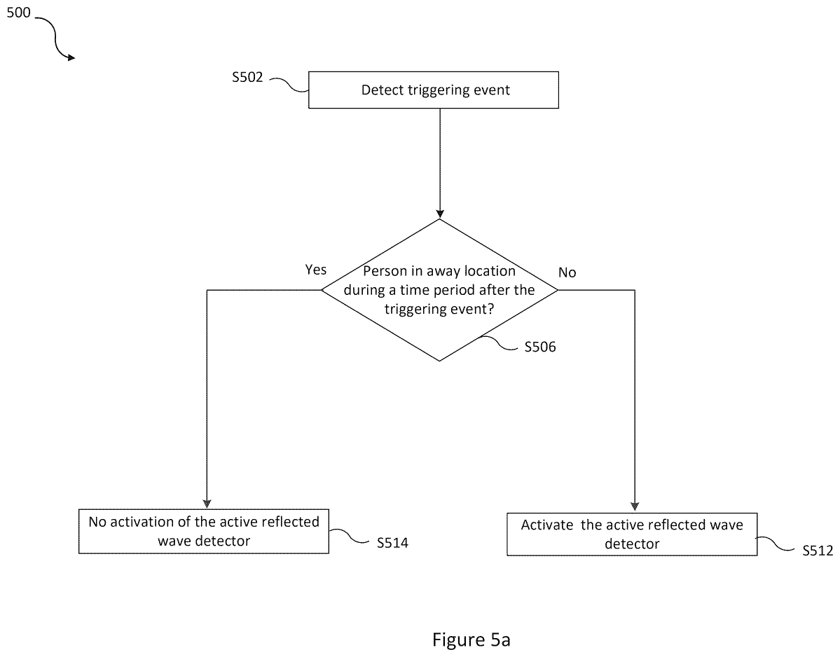

FIG. 4 illustrates a free-standing human body 104 with indications of reflective wave reflections therefrom in accordance with some embodiments.

For each reflected wave measurement, for a specific time in a series of time-spaced reflected wave measurements, the reflected wave measurement may include a set of one or more measurement points that make up a “point cloud”, the measurement points representing reflections from respective reflection points from the environment (e.g. from the active reflected wave detector's monitoring region or region of interest within the environment). In embodiments, the active reflected wave detector 106 provides an output to the processing module 202 for each captured frame as a point cloud for that frame. Each point 302 in the point cloud may be defined by a 3-dimensional spatial position from which a reflection was received, and defining a peak reflection value, and a Doppler value from that spatial position. Thus, a measurement received from a reflective object may be defined by a single point, or a cluster of points from different positions on the object, depending on its size.

In some embodiments, such as in the examples described herein, the point cloud represents only reflections from moving points of reflection, for example based on reflections from a moving target. That is, the measurement points that make up the point cloud represent reflections from respective moving reflection points in the environment. This may be achieved for example by the active reflected wave detector 106 using moving target indication (MTI). Thus, in these embodiments there must be a moving object in order for there to be reflected wave measurements from the active reflected wave detector (i.e. measured wave reflection data), other than noise Alternatively, the processing module 202 receives a point cloud from the active reflected wave detector 106 for each frame, where the point cloud has not had pre-filtering out of reflections from moving points. Preferably for such embodiments, the processing module 202 filters the received point cloud to remove points having Doppler frequencies below a threshold to thereby obtain a point cloud representing reflections only from moving reflection points. In both of these implementations, the processing module 202 accrues measured wave reflection data which corresponds to point clouds for each frame whereby each point cloud represents reflections only from moving reflection points in the environment.

In some embodiments, measured wave reflection data may comprise signals received from an array of transducers (e.g. antennas) and/or may be represented by analog or digital signals that precede a digital signal processing (dsp) component of the apparatus. For example, even in embodiments that generate a point cloud, the measured wave reflection data may be data that precedes calculation of the point cloud by the dsp component.

The region for which the active reflected wave detector is capable of identifying reflections of waves emitted from the active reflected wave detector is a way to define the monitoring region. This is consistent with the above description of the monitoring region being bound by a field of view and at least a maximum range limit.

In other embodiments, no moving target indication (or any filtering) is used. In these implementations, the processing module 202 accrues measured wave reflection data which corresponds to point clouds for each frame whereby each point cloud can represent reflections from both static and moving reflection points in the environment.

FIG. 4 illustrates a map of reflections. The size of the point represents the intensity (magnitude) of energy level of the radar reflections (see larger point 306). Different parts or portions of the body reflect the emitted signal (e.g. radar) differently. For example, generally, reflections from areas of the torso 304 are stronger than reflections from the limbs. Each point represents coordinates within a bounding shape for each portion of the body. Each portion can be separately considered and have separate boundaries, e.g. the torso and the head may be designated as different portions. The point cloud can be used as the basis for a calculation of a reference parameter or set of parameters which can be stored instead of or in conjunction with the point cloud data for a reference object (human) for comparison with a parameter or set of parameters derived or calculated from a point cloud for radar detections from an object (human).

When a cluster of measurement points are received from an object in the environment, a location of a particular part/point on the object or a portion of the object, e.g. its centre, may be determined by the processing module 202 from the cluster of measurement point positions having regard to the intensity or magnitude of the reflections (e.g. a centre location comprising an average of the locations of the reflections weighted by their intensity or magnitude). As illustrated in FIG. 3, the reference body has a point cloud from which its centre has been calculated and represented by the location 308, represented by the star shape. In this embodiment, the torso 304 of the body is separately identified from the body and the centre of that portion of the body is indicated. In alternative embodiments, the body can be treated as a whole or a centre can be determined for each of more than one body part e.g. the torso and the head, for separate comparisons with centres of corresponding portions of a scanned body.

In one or more embodiments, the object's centre or portion's centre is in some embodiments a weighted centre of the measurement points. The locations may be weighted according to a Radar Cross Section (RCS) estimate of each measurement point, where for each measurement point the RCS estimate may be calculated as a constant (which may be determined empirically for the reflected wave detector 106) multiplied by the signal to noise ratio for the measurement divided by R⁴, where R is the distance from the reflected wave detector 106 antenna configuration to the position corresponding to the measurement point. In other embodiments, the RCS may be calculated as a constant multiplied by the signal for the measurement divided by R⁴.

This may be the case, for example, if the noise is constant or may be treated as though it were constant. Regardless, the received radar reflections in the exemplary embodiments described herein may be considered as an intensity value, such as an absolute value of the amplitude of a received radar signal.

In any case, the weighted centre, WC, of the measurement points for an object may be calculated for each dimension as:

$$WC = \frac{1}{{Σ}_{n = 1}^{N} {W}_{n}} {\sum }_{n = 1}^{N} ( {W}_{n} {P}_{n} )$$

### Where:

N is the number of measurement points for the object;
Wₙ is the RCS estimate for the n^{th} measurement point; and
Pₙ is the location (e.g. its coordinate) for the n^{th} measurement point in that dimension.

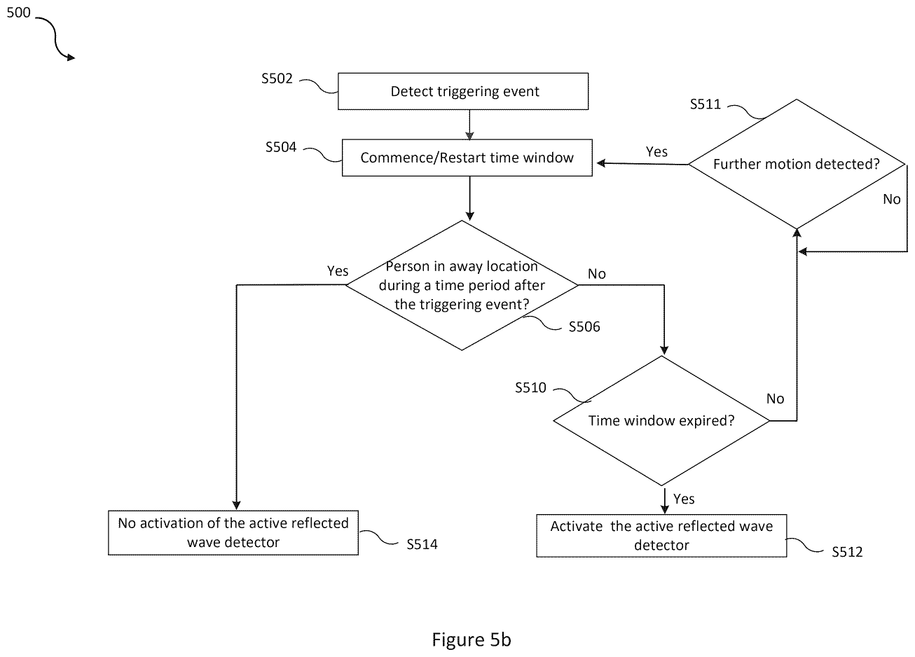

FIG. 5a illustrates an example process 500 performed by the processing module 202 for monitoring an environment to control an active reflected wave detector.

When the process 500 is started, the active reflected wave detector 106 is in an inactivated state. In the inactivated state the active reflected wave detector 106 may be turned off, and therefore in a lower power consumption state. Alternatively, in the inactivated state the active reflected wave detector 106 may be turned on but in a lower power consumption operating state whereby the active reflected wave detector 106 is not performing reflected wave measurements.

At step S502, the processing module 202 detects a triggering event.

In embodiments in which the sensing device 108 is present, the processing module 202 may detect the triggering event in response to receiving data output by the sensing device 108. The data output by the sensing device 108 may be representative of a sensed scenario or phenomenon in the environment. As explained above, the sensing device 108 may, in some embodiments, be configured to detect at least one of motion and presence of a person in a space. Thus, the processing module 202 may detect the triggering event in response to receiving data output by the sensing device 108 which is indicative of motion and/or presence of a person in the space monitored by the sensing device 108. In examples whereby the sensing device 108 is a motion detector, the processing module 202 may detect the triggering event in response to motion detection data output by the motion detector.

Optionally the processing module 202 need not detect the triggering event based on the output of the sensing device 108. For example, the processing module 202 may comprise a timer and perform step S502 once a predetermined time period (e.g. 10 minutes) has expired. Thus in this example, the triggering event is a timer based triggering event. Optionally, the triggering event may be based on such a timer and/or may be based on the output of the sensing device 108.

In yet another example the triggering event may be based on message received from a remote device, for example via the communication module 203 of the monitoring device 202.

At step S506, the processing module 202 determines, based on an output from a different device 104, whether a person is at an away location, which is outside the region of interest of the active reflected wave detector 106, during a time period that is after the triggering event.

The determining step at step S506 may comprise or consist of monitoring the different device 104 for a signal indicative of a person being at an away location, and in response to receiving such a signal, concluding that predefined condition is met, the condition comprising that a person is determined to at the away location during the time period, which may be at any time during the time period.

In an event of an absence of receiving such a signal from any such different device, it may be that the person has remained in the region of interest of the active reflected wave detector 106. As a result, the process 500 proceeds on the basis that it is unknown whether or not the person is or isn't in the region of interest of the active reflected wave detector 106, and thus may activate the active reflected wave detector 106, e.g. to determine whether a person is present in the region of interest and/or a state or activity associated with a person should they be in the region of the interest.

In particular, in response to a predefined criterion being met (the predefined criterion comprises that the time period has expired and the predefined condition was not met), the process 500 proceeds to step S512 where the processing module 202 activates the active reflected wave detector 106 to measure wave reflections from the region of interest within the environment. The processing module 202 may activate the active reflected wave detector 106 by transmitting a suitable command or signal to the active reflected wave detector 106.

In response to satisfaction of the predefined condition comprising that a person is identified at an away location during the time period, the processing module 202 concludes that the predefined criterion is not met and the process proceeds to step S514 where the processing module 202 does not take any steps to activate the active reflected wave detector 106, and thus the active reflected wave detector 106 remains in an inactivated state. Therefore the active reflected wave detector 106 is not activated and the process triggered by the detected event may thereby end.

In embodiments of the present disclosure, a detected presence of an object in, or potentially in, the region of interest may trigger activation of the active reflected wave detector 106. For example, an object may be detected by a motion detector 108 having a motion detection monitoring region that is within, or includes, the region of interest of the active reflected wave detector 106. The method may comprise detecting motion, wherein in an event of a detected motion, a presence is detected by implication.

As shown in FIG. 5a, once it has been determined that a person is not identified at an away location during the time period, the process 500 may, provided the predefined condition is not met, comprise configuring the active reflected wave detector 106 to be in the activated state.

FIG. 5b shows a variant of FIG. 5a in which, in response to detecting the triggering event at S502, the processing module 202 commences a time window at step S504 which is to last a predefined minimum duration. In this embodiment the predefined criterion further comprises that the time window has expired, and thus expiry of the time window is checked at step S510 after determining at step S506 that a person is not identified at an away location during the time period. Once the time window expires the process 500 proceeds to step S512 where the processing module 202 activates the active reflected wave detector 106 to measure wave reflections from the region of interest within the environment. The duration of the time period may be the same or less than the predefined minimum duration of the time window. The expiry of the time period and the expiry of the time window may be one and the same.

Referring to the example in which the sensing device 108 is a motion detector, and the processing module 202 detects the triggering event in response to motion detection data output by the motion detector, the processing module 202 may be configured to include a step S511 by which the processing module 202 restarts the time window in response to further detected motion during the time window, each time such further motion is detected. Thus, the active reflected wave detector 106 is activated after expiry of the time window, which occurs when a time period of a predefined minimum length ends, over the course of which no motion has been detected. Thus, the time window, from a latest of the commencing or restarting until said expiry, consists of or includes the time period. For ease of explanation, in the examples which follow the time window, from a latest of the commencing or restarting until said expiry, consists of the time period. In any case, the predefined length of the time period may be in the range of 15 to 45 seconds, or about 30 seconds in an example.

A rationale behind waiting for a period of no motion to occur before activating the active reflected wave detector 106 is that if such a period of no motion has occurred, it is likely that a person has stopped moving, or at least is not substantially moving, which may be caused by any number of possible states or activities (e.g. sitting, lying on a bed, etc.), but one possibility of which is that the person has fallen and is in need of attention (e.g. they may be stuck lying on the floor).

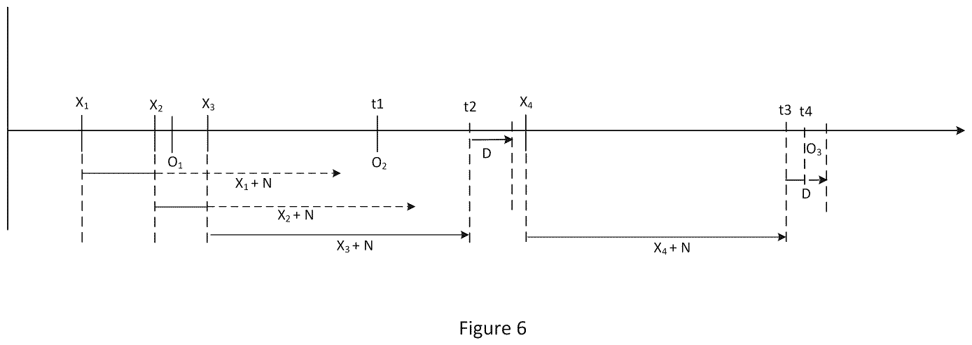

The restarting of the time window in response to further detected motion during the time window is illustrated in the timing diagram of FIG. 6. In FIG. 6, the notation “Xₙ” refers to motion detection performed by the motion detector 108, and the notation “Oₙ” refers to the detection of a person at an away location performed by the different device 104.

Whilst the active reflected wave detector 106 is in an inactivated state, the processing module 202 may detect a first motion detection X₁ based on the output of the motion detector 108. This corresponds to an example triggering event at step S502. As shown in FIG. 6, in response to the first motion detection X₁ a time window N is started by the processing module 202 which corresponds to step S504.

The timing diagram of FIG. 6 shows that the processing module 202 detects a second motion detection X₂ based on the output of the motion detector 108 prior to expiry of the time window N which was started in response to the first motion detection X₁. This causes the time window N to be restarted in response to the second motion detection X₂.

The timing diagram of FIG. 6 also shows that the processing module 202 detects a third motion detection X₃ based on the output of the motion detector 108 prior to expiry of the time window N which was started in response to the second motion detection X₂. This causes the time window N to again be restarted in response to the third motion detection X₃.

In the scenario whereby no person is detected in an away location during the time window N which was started in response to the third motion detection X₃ (i.e. the detection O₂ of a person at an away location does not occur), then at time t2 the processing module 202 would activate the active reflected wave detector 106. Then for a period of time, D, the active reflected wave detector operates to collect measurements from the region of interest to enable identification of a state or activity of a person in the region of interest. During the period D, the active reflected wave detector may be always activated. Alternatively, during the period D the active reflected wave detector may be initially activated and then alternatingly inactivated and reactivated one or more times to produce a collection of time-separated measurements over the course of the period D. For example, active reflected wave detector may be configured to take measurements at the start and end of the period D and be inactivated in the time therebetween. In any case, at the expiry of the period D, the active reflected wave detector would, having completed all needed measurements to make the state/activity identification, be configured to be in its inactivated state. In other words the active reflected wave detector is scheduled to complete the measurements at the expiry of the time period D.

In the scenario illustrated in FIG. 6 whereby there is a detection O₂ of a person at an away location during the time window N which was started in response to the third motion detection X₃ the processing module 202 may determine at t1 (corresponding to the time at which the detection O₂ occurred) that the active reflected wave detector 106 is not to be activated at step S514, or alternatively may determinate at t2 (corresponding to the time at which the time window N expires) that the active reflected wave detector 106 is not to be activated at step S514.

As shown in the timing diagram of FIG. 6, in response to the processing module 202 detecting a fourth motion detection X₄ based on the output of the motion detector 108, a time window N is started by the processing module 202. Upon the time window N, which was started in response to the fourth motion detection X₄, expiring at t3 without a person being detected at an away location, the processing module 202 activates the active reflected wave detector 106 at step S514.

In embodiments of the present disclosure, when the active reflected wave detector 106 is in operating to collect measurements form the region of interest so as to enable identification of the state, activity or condition of a person in the region of interest, the processing module 202 may detect that a person is at an away location during the time period D during which the measurements are to be collected. If this occurs, the processing module 202 may end the collecting of the measurements before the end of the time period D. For example, the processing module 202 may inactivate the active reflected wave detector 106. Additionally or alternatively, if the active reflected wave detector 106 is already inactivated, but with one or more further activation periods scheduled before the end of the time period D, then then such further activation periods may be aborted. For example in the timing diagram of FIG. 6, if the active reflected wave detector 106 as activated upon reaching t3, thereby commencing the time period D, then the detection O₃ of a person at an away location at t4, during the time period D, would cause the active reflected wave detector 106 end collecting measurements, and would be held in an inactivated state, prior to the end of the time period D. By doing so, power may be saved when a person is determined not in the region of interest while the active reflected wave detector is in a process of collecting measurements to classify a state/activity/condition of a person in the region of interest.

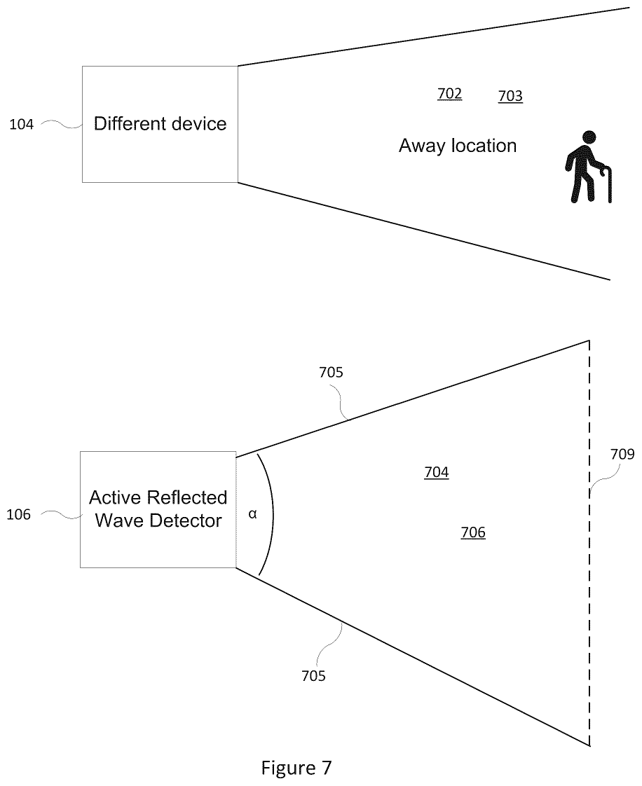

FIG. 7 illustrates an example of how the different device 104 may monitor an away location 702, which may be a monitoring region 703 of the different device 104. FIG. 7 further illustrates how the active reflected wave detector 106 is associated with a monitoring region 704. The monitoring region 704 may be bound by a field of view, which in the context herein may be defined as a horizontal angle α between boundaries 705 and may also be defined by a vertical angle (not shown). In FIG. 7, a dashed line 709 is used to indicate a span of the region of interest 706 of the active reflected wave detector 106. Thus in the example of FIG. 7, the field of view and the span are the same. The line 709 may also be treated as indicating a furthest boundary of the region of interest 706. As will be appreciated the monitoring region 704 would therefore cover a range at least sufficient to include the region of interest. In FIG. 7, the region of interest 706 may be taken as being the same as the monitoring region 704. In the example of FIG. 7, the away location 702 is non-overlapping with the region of interest 706 of the active reflected wave detector 106. In this example the away location 702 corresponds to a monitoring region 703 of the different device 104.

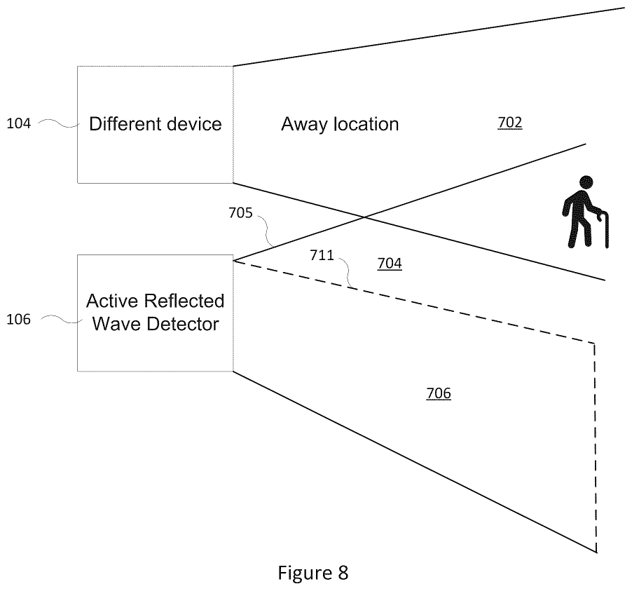

In the example of FIG. 8, the region of interest 706 is within, i.e. only a part of, the monitoring region 704, as indicated by having one of its lateral boundaries 711, being inward of the corresponding lateral boundary 705 of the monitoring region 704. In the example of FIG. 8, whilst the monitoring region 704 overlaps with the away location 702, the away location 702 is non-overlapping with the region of interest 706 of the active reflected wave detector 106.

A database accessible to the processing module 202 may optionally include the locations corresponding to the active reflected wave detector 106 and the different device 104 to determine that output from the different device 104 corresponds to a location outside the region of interest. For example the database may define different room designations to the region of interest and the away location, respectively. Alternatively, the active reflected wave detector 106 may be a preconfigured based on the assumption that the away location corresponds to a location outside the region of interest, and it is incumbent on an installer to make this so when installing the active reflected wave detector 106 and/or the different device 104.

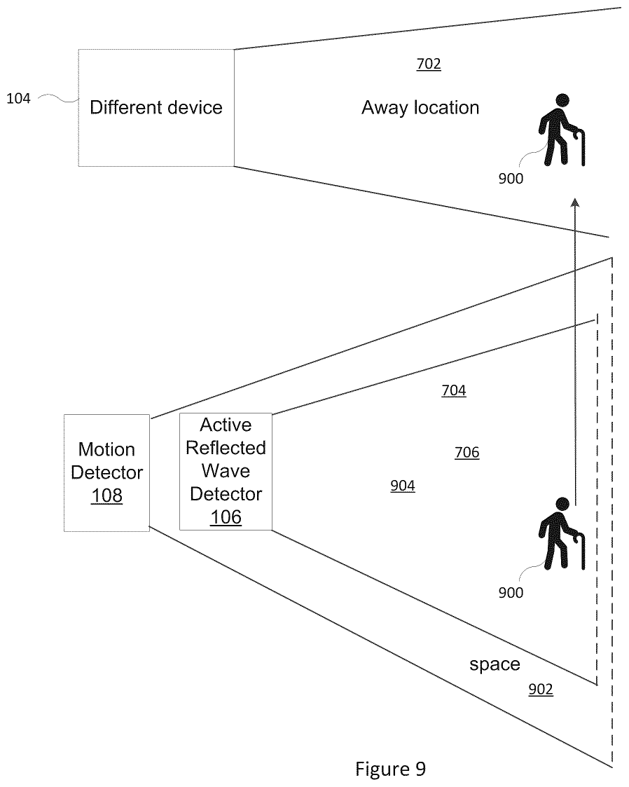

FIG. 9 illustrates a scenario whereby the processing module 202 does not take any steps to activate the active reflected wave detector 106, and thus the active reflected wave detector 106 remains in an inactivated state.

In the scenario illustrated in FIG. 9 the sensing device 108 is a motion detector, and the processing module 202 detects the triggering event in response to motion detection data output by the motion detector. In the event of the processing module 202 detecting the person 900 in the space 902 based on the output of the motion detector 108, the processing module 202 commences the time window N. If the person 900 travels outside of the space and into an away location monitored by the different device 104 prior to expiry of the time window N, the time window N may expire with no further motion detected by the motion detector 108 during the time window N. In this example, due to the processing module 202 determining, based on an output from the different device 104, that a person is at an away location during the time window N, the processing module 202 will not activate the active reflected wave detector 106.

The space 902 monitored by the sensing device 108 may be defined by a horizontal field of view that includes a horizontal field of view 904 needed by the active reflected wave detector 106 in order for the active reflected wave detector 106 to detect objects in its region of interest 706. The space 902 monitored by the sensing device 108 in the monitoring device 200 may additionally or alternatively extend to a distance from the monitoring device 200 that is at least a range needed by the active reflected wave detector 106 in the monitoring device 200 in order for the active reflected wave detector 106 to detect objects in the region of interest 706. In some embodiments, like in the example illustrated in FIG. 9, the space 902 monitored by the sensing device 108 may horizontally extend beyond the region of interest 706 both in lateral terms and also in terms of the distance to which it extends from the monitoring device 200. In some embodiments, like in the example illustrated in FIG. 9, the space monitored by the sensing device 108 may horizontally extend beyond the monitoring region 704 both in lateral terms and also in terms of the distance to which it extends from the monitoring device 200.

In embodiments of the present disclosure, once the active reflected wave detector is in an activated state at step S512, the processing module 202 accrues measured wave reflection data from the active reflected wave detector 106.

The processing module 202 may determine a status of an environment (more particularly, of the region of interest, within the environment 100, of the active reflected wave detector 106) and/or of a person therein based on the measured wave reflection data. Determining a status of the environment may comprise detecting whether a person is in the environment, and in an event that a person is not detected in the environment determining that the environment is unoccupied. Determining a status may comprise detecting whether a person is in the environment and in an event that a person is detected in the environment determining that the environment is occupied. Determining a status of a person may comprise determining a state of a person detected in the environment.

In operation, when activated the active reflected wave detector 106 performs one or more reflected wave measurements at a given moment of time, and over time these reflected wave measurements can be correlated by the processing module 202 with the presence of a person and/or a state and/or activity of the person and/or a condition of the person.

The processing module 202 is configured to process the measured wave reflection data to detect whether a person is in the environment and, if a person is detected, detect a state or activity of the person, which in example includes at least determining whether a person in the environment has fallen. This need not be a two-step process i.e. of looking for a person and then classifying them. For example, the processing module 202 may take the output of the active reflected wave detector 106 and do a classification, wherein one of the outputs of the classification is that there is no person, or in other embodiments it may only conclude that there is no person if it fails to perform a classification of a person's status/activity.

In the context of the present disclosure, an activity of a person may refer to what action the person is involved in (e.g. what they are engaged in or what they are doing) over time (i.e. the time taken to collect the frame(s) for performing the classification). Examples include watching TV, eating, conversing, walking and playing an instrument. It will be appreciated that some activities (e.g. walking) could be equally categorized as being states.

As used herein performing a classification of a person's status/activity may comprise identifying only a state, only an activity or both a state and an activity. An example of identifying both a state and an activity may be that a person is respectively both sitting and, at the same time, eating.

When classifying the state of a person, the processing module 202 may perform a determination that the person is in a fall position (i.e. a position that is consistent with them haven fallen). In embodiments of the present disclosure the determination that the person is in a fall position is used as an indicator that the person may be in need of help. Being in a position which is consistent with the person having fallen does not necessarily mean they have fallen, or have fallen such that they need help. For example, they may be on the floor for other reasons, or they may have had a minor fall from which they can quickly recover. However, if they remain in a fall position for sufficient time it may be concluded that they are sufficiently likely to have fallen to be classified by the processing module 202 as being in a fall condition, and the processing module 202 may therefore take appropriate action accordingly, e.g. by sending a notification to a remote device.

In some embodiments, the classification performed by the processing module 202 may provide further detail on the non-fall condition for example, the processing module 202 may be able to classify the person as being in a state from one or more of: a free-standing state (e.g. they are walking); a safe supported state which may be a reclined safe supported state whereby they are likely to be safely resting (e.g. a state in which they are in an elevated lying down position, or in some embodiments this may additionally encompass being in a sitting position on an item of furniture); and a standing safe supported state (e.g. they are standing and leaning on a wall). In other embodiments the non-fall states may be grouped differently. For example, the non-fall states may include a stationary non-floor position (encompassing both a reclined safe supported state and a standing stationary state whether supported or not in the standing state) and an ambulatory state. The processing module 202 may be able to classify the person as crawling, which may be regarded as a fall state or a non-fall state (given that if the person has fallen the person is still able to move so may be regarded as less critical) dependent on how the processing module 202 is configured.

In the process of determining whether a person is in a fall position, in response to the person being classified as being in a fall position, the active reflected wave detector 106 may be deactivated. The processing module 202 may then wait a predetermined amount of time and then reclassify, based on further measurements from the active reflected wave detector, to see if the person is still in the same position, and if so, determine that there is a person in a fall condition (because they have been in a fall position for some amount of time deemed to indicate they may need help).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer implemented method of monitoring an environment to control an active reflected wave detector installed in a premises, wherein the active reflected wave detector is part of a system comprising at least one different device to the active reflected wave detector that is also installed in the premises, the method comprising:
detecting a triggering event;
determining, based on an output from at least one different device to the active reflected wave detector, whether a person is detected as being at an away location in the premises that is outside a region of interest of the active reflected wave detector during a time period that is after the triggering event;
in response to a predefined criterion being met, switching the active reflected wave detector from a first state to operate in a second state in which the active reflected wave detector measures wave reflections from the region of interest within the environment, wherein the active reflected wave detector consumes more power in the second state than in the first state, the predefined criterion comprising that the time period has expired; and
in response to satisfaction of a condition comprising that a person is detected as being at an away location during the time period, concluding that the predefined criterion is not met.

2.-20. (canceled)

21. A non-transitory computer-readable storage medium comprising instructions which, when executed by a processor cause the processor to perform the method of claim 1.

22. A device for monitoring an environment to control an active reflected wave detector installed in a premises, the active reflected wave detector being for use in a system comprising at least one different device to the active reflected wave detector that is also installed in the premises, the device being configured to:
detect a triggering event;
determine, based on an output from at least one different device to the active reflected wave detector, whether a person is detected as being at an away location in the premises that is outside a region of interest of the active reflected wave detector during a time period that is after the triggering event;
in response to a predefined criterion being met, switch the active reflected wave detector from a first state to operate in a second state in which the active reflected wave detector measures wave reflections from the region of interest within the environment, wherein the active reflected wave detector consumes more power in the second state than in the first state, the predefined criterion comprises that the time period has expired, and in response to satisfaction of a condition comprising that a person is detected as being at an away location during the time period, it is concluded that the predefined criterion is not met.

23. The device of claim 22, wherein the device comprises the active reflected wave detector.

24. The device of claim 22, wherein each of the at least one different device is housed in a housing external to the device, and the device comprises a communications interface to receive the output from the at least one different device.

25. The device of claim 22, wherein the device consumes more power when the active reflected wave detector is in the second state than when the active reflected wave detector is in the first state.

26. (canceled)

27. A system configured to perform a method according to claim 1, the system comprising the active reflected wave detector and one or more of the at least one different device.

28. (canceled)

29. The device of claim 22, wherein the device is further configured to:
during a time period commencing with switching of the active reflected wave detector to the second state and ending with a scheduled completing of collecting measurements from the region of interest, determine, based on an output from the different device whether a person is detected as being at the away location; and
in an event that a person is detected as being at the away location during the time period, end the collecting of the measurements before the end of the time period.

30. The device of claim 22, wherein the active reflected wave detector is associated with a monitoring region and the region of interest is the monitoring region.

31. The device of claim 22, wherein the active reflected wave detector is associated with a monitoring region, and the region of interest consists of one or more sub-regions that make up less than an entirety of the monitoring region.

32. The device of claim 22, wherein detection of the triggering event is based on an input from a sensing device for detecting at least one of motion and presence of a person in a space in the premises.

33. The device of claim 32, wherein the space is correlated with said region of interest.

34. The device of claim 32, wherein the input is motion detection data.

35. The device of claim 34, wherein the motion detection data is measured by PIR motion detector.

36. The device of claim 32, wherein the device is further configured to:
commence a time window in response to the detected motion,
wherein in response to further detected motion during the time window, the device is configured to restart said time window, wherein the predefined criterion comprises that the time window has expired.

37. The device of claim 32, wherein the space is non-overlapping with an away location.

38. The device of claim 22, wherein the region of interest corresponds to a first room of a premises or a part thereof.

39. The device of claim 38, wherein the away location is a different room of the premises to the first room.

40. The device of claim 22, wherein the output from the at least one different device indicates whether a person has interacted with a different device of said at least one different device, wherein interaction with the different device requires a person to be at an away location.

41. The device of claim 22, wherein the at least one different device comprises a motion detector arranged to monitor an away location.
